(19) United States
(12) Patent Application Publication
(10) Pub. No.: US 2010/0300484 A1
(43) Pub. Date: Dec. 2, 2010

(54) CLEANING DEVICE AND CLEANING PERFORMANCE MAINTAINING METHOD

(75) Inventors: Eiji GUMBE, Kanagawa-ken (JP); Eizo KURITA, Shizuoka-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/780,483

(22) Filed: May 14, 2010

Related U.S. Application Data
(60) Provisional application No. 61/181,987, filed on May 28, 2009.
(60) Provisional application No. 61/183,422, filed on Jun. 2, 2009.

(51) Int. Cl. B08B 1/00

(52) U.S. Cl. 134/6; 399/350; 15/256.51

(57) ABSTRACT

According to one embodiment, A cleaning device includes a cleaning blade, a support section, a container and an elastic sheet. the support section supports the cleaning blade while pressing an end portion of the cleaning blade to a cleaning object surface. the container has an opening portion at a side opposite to the cleaning object surface and contains a removal object scraped from the cleaning object surface by the cleaning blade. one end of the elastic sheet is fixed to a peripheral portion of the opening portion of the container. the other end of the elastic sheet is in contact with a non-opposite surface as a surface of the cleaning blade at a side not opposite to the cleaning object surface. the elastic sheet guides the removal object scraped from the cleaning object surface by the cleaning blade into the container. the elastic sheet includes, on at least a part of a surface opposite to the cleaning blade, a slope-shaped portion having a side surface inclined to both the non-opposite surface and the surface of the elastic sheet opposite to the cleaning blade in a state of contact with the non-opposite surface.

### CROSS-REFERENCE TO RELATED APPLICATION

This application is based upon and claims the benefit of priority from: U.S. provisional application 61/181,987, filed on May 28, 2009; and U.S. provisional application 61/183,422, filed on Jun. 2, 2009, the entire contents of each of which are incorporated herein by reference.

### FIELD

This specification relates to maintaining the performance of a cleaning blade of a cleaning unit provided in an image forming apparatus.

### BACKGROUND

Hitherto, in an image forming apparatus of an electrophotographic system, a cleaning unit is known which includes a cleaning blade to scrape residual toner remaining on a photoreceptor or an intermediate transfer body after a toner image is transferred to a recording medium.

The cleaning blade protrudes to the outside from an opening formed in a cleaner housing outer wall, and is rotatably supported by a support section so that the cleaning blade contacts with and separates from a roller or a belt as a cleaning object. Besides, a spring or the like urges the cleaning blade to the roller or the belt as the cleaning object.

In the cleaning unit having the structure as stated above, in order to prevent the toner scarped by the cleaning blade from falling from a gap between the cleaning blade and the cleaner housing, there is known a structure in which the gap is closed by an elastic sheet.

In the structure, there is a fear that the surface of the elastic sheet and the surface of the cleaning blade become conformable in shape to each other and are brought into intimate contact, and prevent the rotation of the cleaning blade.

There is a case where the application of lubricant powder to a portion where the cleaning blade and the elastic sheet are in intimate contact can not sufficiently suppress the intimate contact of both due to variation in the way of application.

### BRIEF DESCRIPTION OF THE DRAWINGS

FIG. 1 is a longitudinal sectional view of an image forming apparatus.

FIG. 2 is a perspective view showing a positional relation between a photoconductive drum and a cleaning unit.

FIG. 3 is a perspective view showing the cleaning unit single body, in which the photoconductive drum is removed.

FIG. 4 is a sectional view taken along plane A (plane parallel to an x-z plane) of FIG. 2.

FIG. 5 is an enlarged view showing a contact state between a cleaning blade and an elastic sheet.

FIG. 6 is a view of an example of a print pattern of silk printing applied to the elastic sheet.

FIG. 7 is an enlarged view of a contact position between the silk printing pattern on the elastic sheet and the cleaning blade.

FIG. 8 is an enlarged view of a contact state between a cleaning blade and a related art elastic sheet.

FIG. 9 is a view showing an example of another print pattern of silk printing applied to an elastic sheet.

FIG. 10 is a perspective view of a secondary transfer unit including a lubricant agent supply device.

FIG. 11 is a perspective view of the lubricant agent supply device.

FIG. 12 is a partial perspective view of a component of the lubricant agent supply device.

FIG. 13 is a view of a lubricant agent supply device of a fourth embodiment.

FIG. 14 is a view of a lubricant agent supply device of a fifth embodiment.

FIG. 15 is a view of a lubricant agent supply device of a sixth embodiment.

FIG. 16 is a view of a lubricant agent supply device of a seventh embodiment.

### DETAILED DESCRIPTION

In general, according to one embodiment, A cleaning device includes a cleaning blade, a support section, a container and an elastic sheet. the support section supports the cleaning blade while pressing an end portion of the cleaning blade to a cleaning object surface. the container has an opening portion at a side opposite to the cleaning object surface and contains a removal object scraped from the cleaning object surface by the cleaning blade. one end of the elastic sheet is fixed to a peripheral portion of the opening portion of the container. the other end of the elastic sheet is in contact with a non-opposite surface as a surface of the cleaning blade at a side not opposite to the cleaning object surface. the elastic sheet guides the removal object scraped from the cleaning object surface by the cleaning blade into the container. the elastic sheet includes, on at least a part of a surface opposite to the cleaning blade, a slope-shaped portion having a side surface inclined to both the non-opposite surface and the surface of the elastic sheet opposite to the cleaning blade in a state of contact with the non-opposite surface.

Hereinafter, embodiments will be described with reference to the drawings.

### First Embodiment

First, a first embodiment will be described.

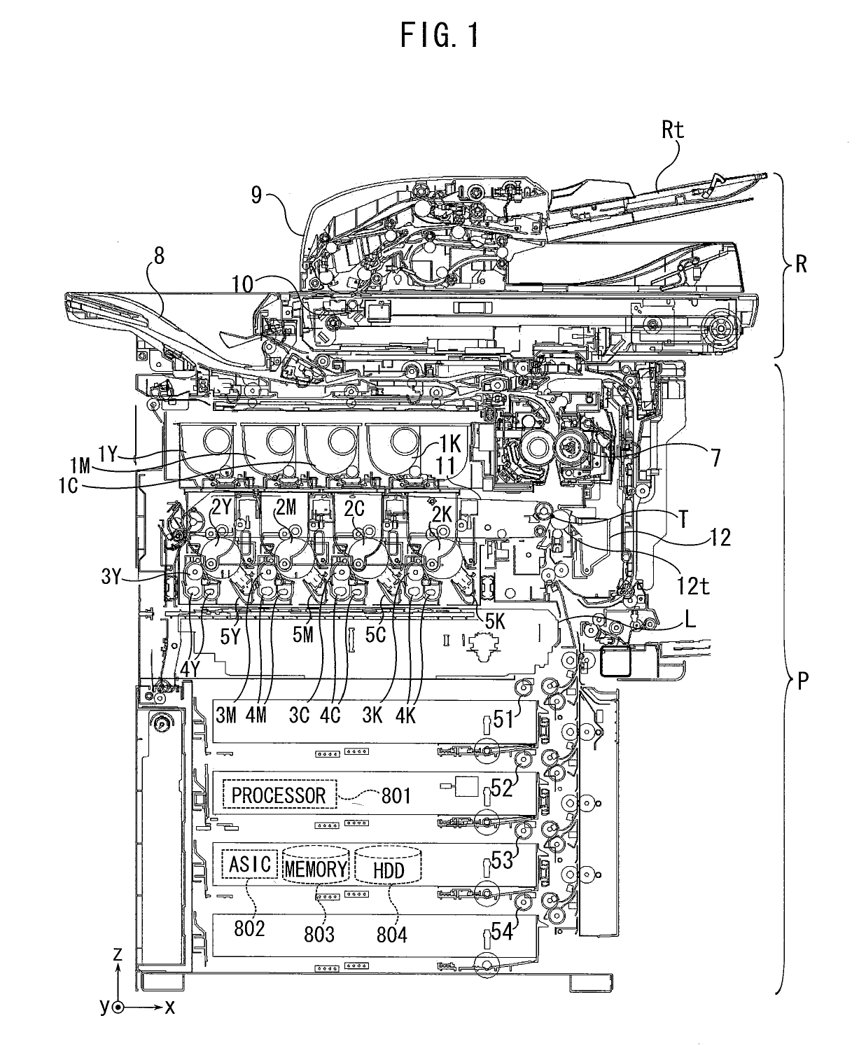

FIG. 1 is a longitudinal sectional view of an image forming apparatus.

The image forming apparatus includes an image reading section R and an image forming section P.

The image reading section R scans and reads an image of a sheet document and a book document.

The image forming section P forms a developer image on a sheet based on the image read from the document by the image reading section R or image data transmitted to the image forming apparatus from an external equipment.

The image reading section R includes an auto document feeder 9. The image reading section R reads an image of a document which is placed on a document tray Rt and is automatically fed by the auto document feeder 9 or an image of a document placed on a not-shown document stand.

The image forming section P includes pickup rollers 51 to 54, photoreceptors 2Y to 2K, developing rollers 3Y to 3K, mixers 4Y to 4K, cleaning units 6Y to 6K (corresponding to a cleaning device), an intermediate transfer belt 11, a secondary transfer unit 12, a fixing device 7, a discharge tray 8, toner cartridges 1Y to 1K and a laser sweep unit L.

The image forming apparatus includes a processor 801, an ASIC (Application Specific Integrated Circuit) 802, a MEMORY 803 and a HDD (Hard Disk Drive) 804. The processor 801 performs various processings in the image forming apparatus. The processor 801 executes programs stored in the MEMORY 803 and realizes various functions.

The MEMORY 803 may be, for example, a RAM (Random Access Memory), a ROM (Read Only Memory), a DRAM (Dynamic Random Access Memory), an SRAM (Static Random Access Memory), a VRAM (Video RAM) or the like.

Hereinafter, as an example of processing in the image forming apparatus, the outline of a copy processing will be described.

First, the pickup rollers 51 to 54 convey a sheet from a cassette to a sheet conveyance path. Plural roller pairs conveys the sheet to a secondary transfer position T.

The image reading section R reads images of plural sheet documents and obtains image data.

The laser sweep unit L forms electrostatic latent images on the photoconductive surfaces of the photoreceptors 2Y, 2M, 2C and 2K based on the image data.

The mixers 4Y to 4K in developing units agitate developer in the developing units. The developing rollers 3Y to 3K supply the developer to the electrostatic latent images on the photoreceptors 2Y to 2K, and develop the electrostatic latent images on the photoconductive surfaces of the photoreceptors. The toner cartridges 1Y to 1K supply toner to these developing units.

The photoreceptor transfers the developer image onto the belt surface of the intermediate transfer belt 11 (so-called primary transfer). The intermediate transfer belt conveys the developer image carried on the rotating belt surface to the secondary transfer position T. The intermediate transfer belt 11 and a secondary transfer roller 12t pinch and convey the sheet at the secondary transfer position T, and transfer the toner image on the intermediate transfer belt 11 to the sheet.

The fixing unit 7 heats and fixes the developer image on the sheet to the sheet.

The plural conveyance roller pairs successively discharge the sheet onto the discharge tray 8 after heating and fixing.

Next, the schematic structure of the cleaning units 6Y to 6K will be described. Since the respective cleaning units 6Y to 6K have the same structure, for conveyance of explanation, the description will be made while using the cleaning unit 6k as an example.

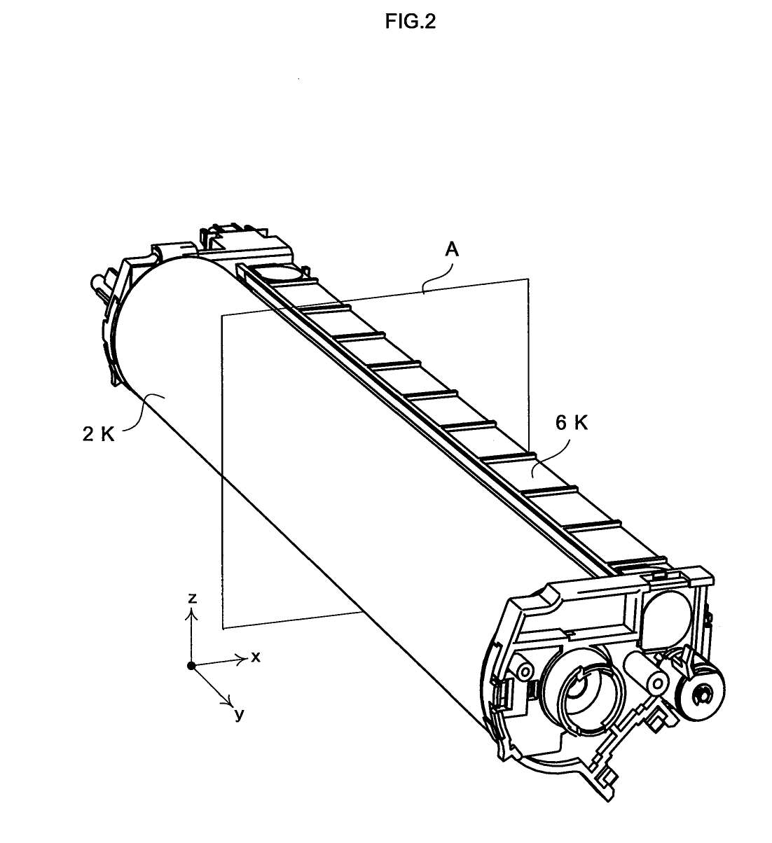

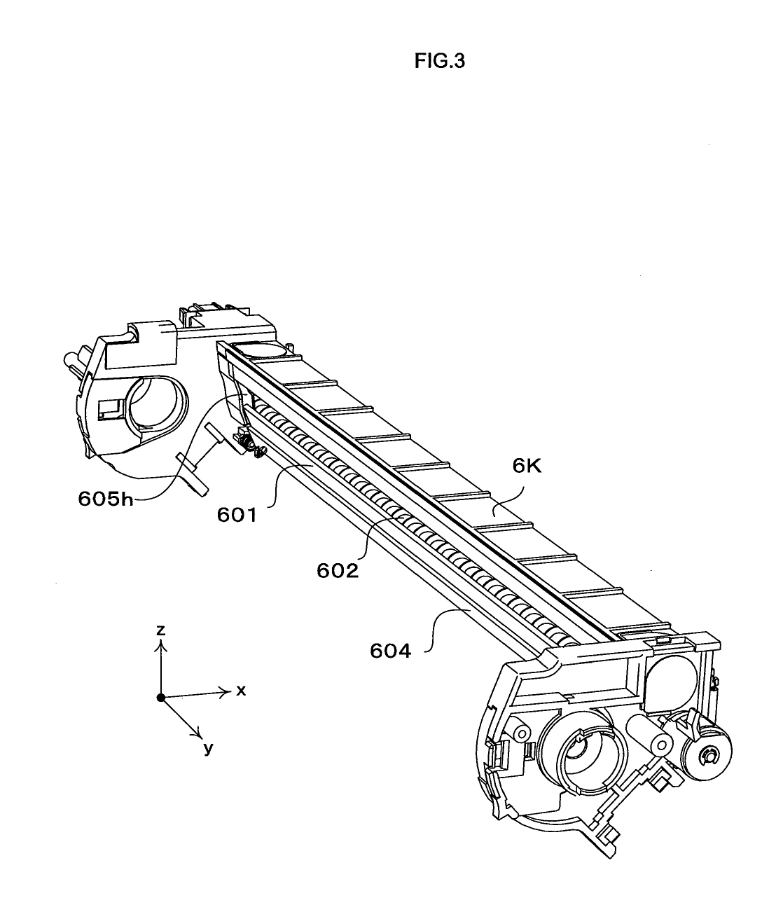

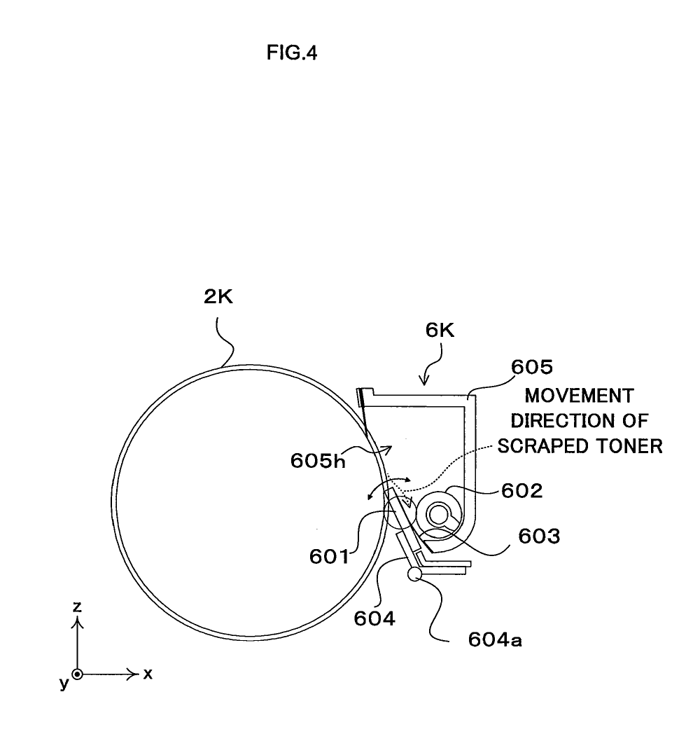

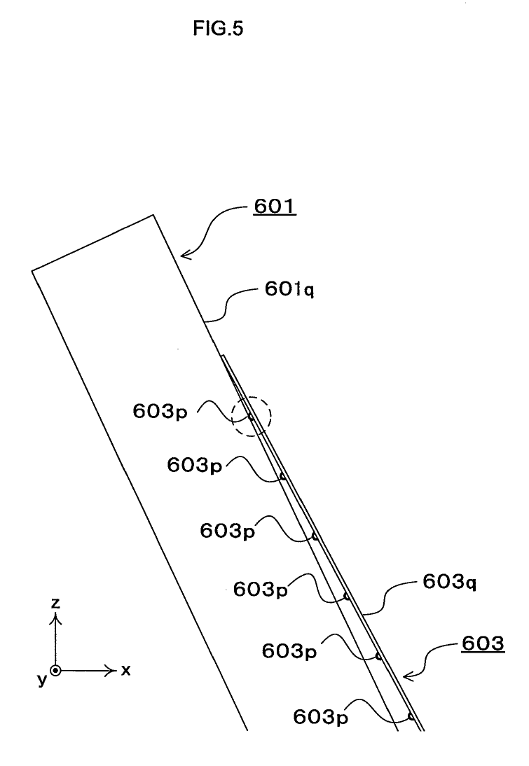

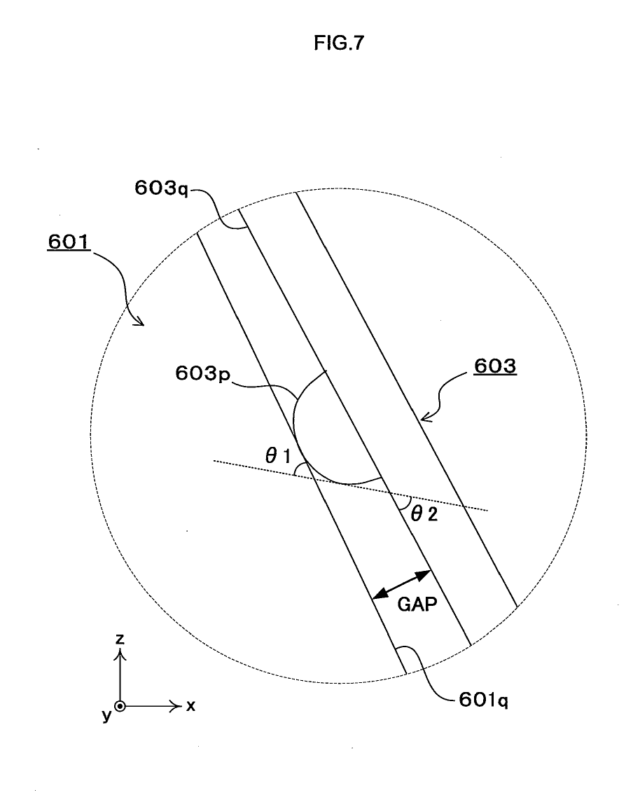

FIG. 2 is a perspective view showing a positional relation between a photoconductive drum and a cleaning unit. FIG. 3 is an outer appearance perspective view of the cleaning unit single body. FIG. 4 is a sectional view taken along plane A (plane parallel to an x-z plane) of FIG. 2. FIG. 5 is an enlarged view showing a contact state between a cleaning blade and an elastic sheet. FIG. is a view of an example of a print pattern of silk patterning applied to the elastic sheet. FIG. 7 is an enlarged view of a contact position (within a range surrounded by a broken line S) between the silk printing pattern on the elastic sheet and the cleaning blade.

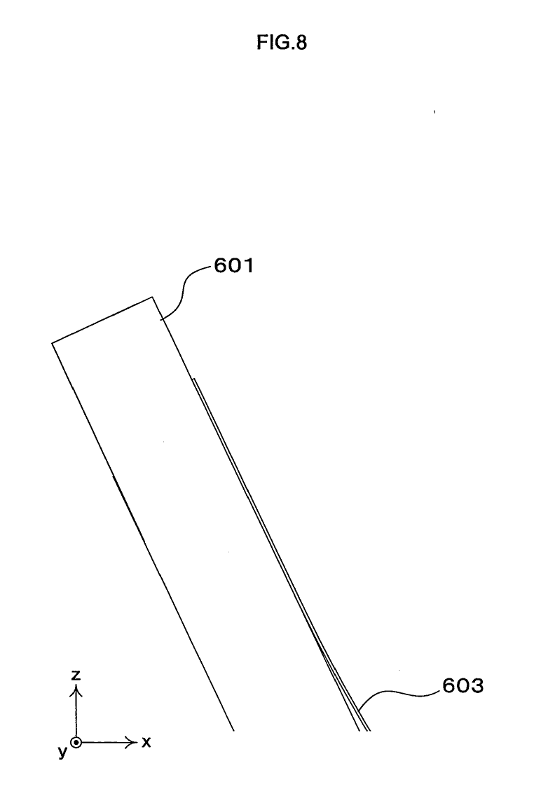

FIG. 8 is an enlarged view showing a contact state between a cleaning blade and a related art elastic sheet.

The cleaning unit 6K scrapes residual toner remaining on the photoconductive surface of the photoreceptor 2K, and cleans the photoconductive surface.

Specifically, the cleaning unit 6K includes a cleaner housing 605, a cleaning blade 601, a waste toner conveyance auger 602, a support section 604 and an elastic sheet 603.

The cleaning blade 601 can be formed of a plate-like elastic material of polyurethane elastomer or the like having a hardness of 60° to 70° (JIS-A).

The support section 604 supports the cleaning blade 601 while pressing an end portion of the cleaning blade 601 to the photoconductive surface as the cleaning object surface. The support section 604 supports an end portion of the cleaning blade 601 so that the cleaning blade 601 can rotate around a support shaft 604a.

The cleaner housing 605 (container) includes an opening portion 605h at a side opposite to the photoconductive surface, and contains a removal object, such as residual toner, scraped from the photoconductive surface by the cleaning blade 601.

One end of the elastic sheet 603 is fixed to a peripheral portion of the opening portion 605h of the container 605, and the other end contacts with a surface (corresponding to a non-opposite surface) of the cleaning blade 601 at a side not opposite to the photoconductive surface. Besides, the elastic sheet 603 guides the removal object scraped from the photoconductive surface by the cleaning blade 601 into the cleaner housing 605. The elastic sheet 603 has a convex portion on at lest a part of a surface opposite to the cleaning blade 601.

Besides, the elastic sheet 603 closes a gap between the cleaning blade 601 and the opening portion 605h of the cleaner housing 605 so that the waste toner scraped by the cleaning blade 601 does not leak through the gap to the outside. The one end of the elastic sheet 603 is bonded to the peripheral portion of the opening portion 605h of the cleaner housing 605 by a double-sided tape or adhesive, and the other end of the elastic sheet 603 contacts with the cleaning blade 601.

The elastic sheet 603 can be formed of an elastic member of a polyester film or the like having a thickness of about 0.05 mm, so that a large influence is not exerted on the rotation operation of the cleaning blade 601 around the support shaft 604a.

The cleaning blade 601 is elastically urged by the support section 604 so that the tip contacts with the photoconductive surface of the photoreceptor 2K, scrapes the residual toner remaining on the photoconductive surface of the photoreceptor 2K after the transfer processing of the toner image, and guides it into the cleaner housing 605.

The waste toner conveyance auger 602 rotates around a rotation axis extending in a y-axis direction, and discharges the waste toner collected in the cleaner housing 605 to the outside of the cleaner housing 605 while agitating it.

Hereinafter, the structure of the elastic sheet 603 will be described in detail.

The elastic sheet 603 includes a convex portion 603p (corresponding to a slope-shaped portion) in a surface area which is at least a part of the surface opposite to the cleaning blade 601 and is other than the vicinity of a tip.

That is, the elastic sheet 603 includes the convex portion (slope-shaped portion) 603p which is provided on at least a part of the surface opposite to the cleaning blade 601 and has a side surface inclined to both “a non-opposite surface 601q” and “a surface 603q of the elastic sheet 603 opposite to the cleaning blade 601” in a state of contact with the non-opposite surface 601q. In an enlarged view shown in FIG. 7, the convex portion 603p has, on at least a part, a side surface inclined to “the non-opposite surface 601q” by an angle θ1 and inclined to “the surface 603q of the elastic sheet 603 opposite to the cleaning blade 601” by θ2.

Incidentally, “inclination” here means a state having an angle to “the non-opposite surface 601q” and “the surface 603q of the elastic sheet 603 opposite to the cleaning blade 601”, and includes a perpendicular state.

Besides, here, although the case where the cross section of the convex portion has substantially a semicircular shape is exemplified, a polygonal sectional shape such as a triangle or a square can also be adopted. Besides, “inclined” means a state where for example, when the contour of the cross section of the convex portion is a curved line, a tangent to the curved line is inclined to “the non-opposite surface 601q” and “the surface 603q of the elastic sheet 603 opposite to the cleaning blade 601”.

The convex portion 603p is not formed in the vicinity of the tip of the elastic sheet 603, because the vicinity of the tip of the elastic sheet 603 (preferably, an edge portion of the tip of the elastic sheet 603) is required to be in firm contact with the cleaning blade 601 in order to sufficiently exhibit the function to close the gap between the cleaning blade 601 and the opening portion 605h.

The convex portion 603p on the elastic sheet 603 can be formed as, for example, a print pattern by silk printing.

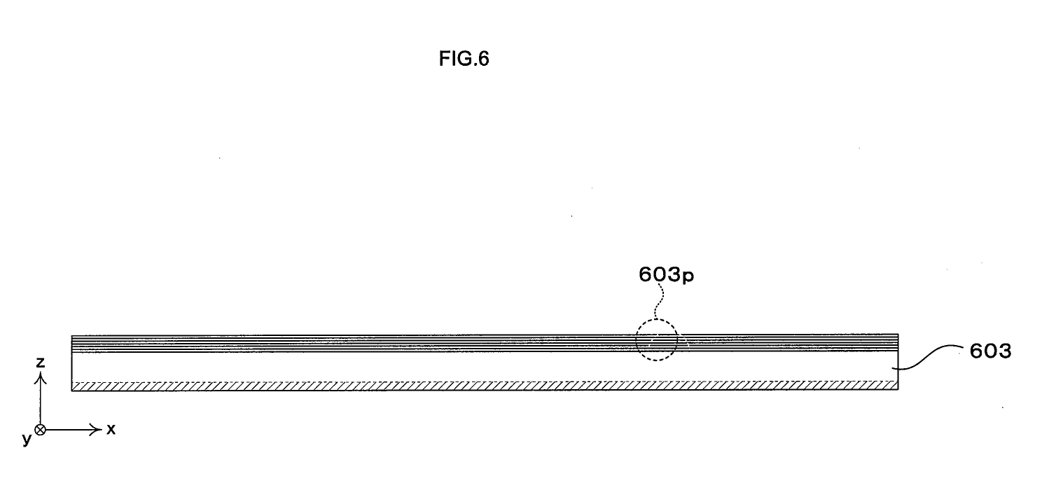

Specifically, the convex portion 603p is provided in such a state that plural linear patterns (see, for example, FIG. 6) extending in the direction (here, the y-axis direction) perpendicular to the direction of relative movement of the photoconductive surface and the cleaning blade 601 are arranged.

Incidentally, as an area where the convex portion 603a of the elastic sheet 603 is to be formed, there can be mentioned “a surface area having a possibility of surface contact with the cleaning blade 601 (there is a possibility of intimate contact with the cleaning blade 601) when there is no convex portion 603a”. The elastic sheet 603 includes the convex portion 603a in almost all range in the y-axis direction and a range positioned between the center position in a direction V extending to the cleaning blade 601 from the opening portion 605h and the tip side.

Subsequently, the operation of the cleaning blade 601 and the elastic sheet 603 will be described.

The cleaning blade 601 is urged to the photoconductive surface side of the photoreceptor by a not-shown spring while using the support shaft 604a as a fulcrum. In order to maintain the excellent cleaning performance of the cleaning blade 601, it is desirable that the rotation operation using the support shaft 604a as the fulcrum can be smoothly performed. Accordingly, also with respect to the elastic sheet 603 pressed to contact with the cleaning blade 601, similarly, in order not to prevent the rotation operation of the cleaning blade 601, it is preferable that the elastic sheet slides on the cleaning blade 601 according to the rotation operation.

In a related art structure shown in FIG. 8, the flatness of a surface area of the elastic sheet 603 having a possibility of surface contact with the cleaning blade 601 is high, and a partial surface of the elastic sheet 603 comes in surface contact with the cleaning blade 601. Accordingly, the elastic sheet 603 becomes conformable to the cleaning blade 601 and comes in intimate contact therewith.

When the cleaning blade 601 and the elastic sheet 603 comes in intimate contact with each other, the slide of the elastic sheet 603 on the cleaning blade 601 becomes worse, the smooth rotation operation of the cleaning blade 601 is inhibited, and there is a fear that a defect such as curling of the cleaning blade 601 occurs.

On the other hand, by performing silk printing to form the convex portion 603p of the print pattern shown in FIG. 5 and FIG. 6 on the surface of the elastic sheet 603, as shown in FIG. 5, a gap having the thickness of the convex portion 603p (the amount of protrusion from the surface of the elastic sheet) can be ensured between the cleaning blade 601 and the elastic sheet 603, and it is possible to prevent the surface contact (intimate contact) between the cleaning blade 601 and the elastic sheet 603. Besides, the rotation operation of the cleaning blade 601 can be always kept in an excellent state, and the stabilization of the cleaning performance of the cleaning device can be obtained.

Incidentally, it is needless to say that it is preferable that the convex portion itself formed on the elastic sheet 603 has a low friction resistance against the material of the cleaning blade 601.

When plural convex portions are arranged on the elastic sheet 603, it is preferable that an interval between the convex portions is set to such an interval that the surface of the elastic sheet 603 does not contact with the cleaning blade 601 in the state where the elastic sheet 603 is pressed to the cleaning blade 601 and is bent.

### Second Embodiment

A second embodiment will be described.

The second embodiment is a modified example of the first embodiment. Hereinafter, a portion having the same function as a portion in the foregoing structure is denoted by the same reference numeral and its description is omitted.

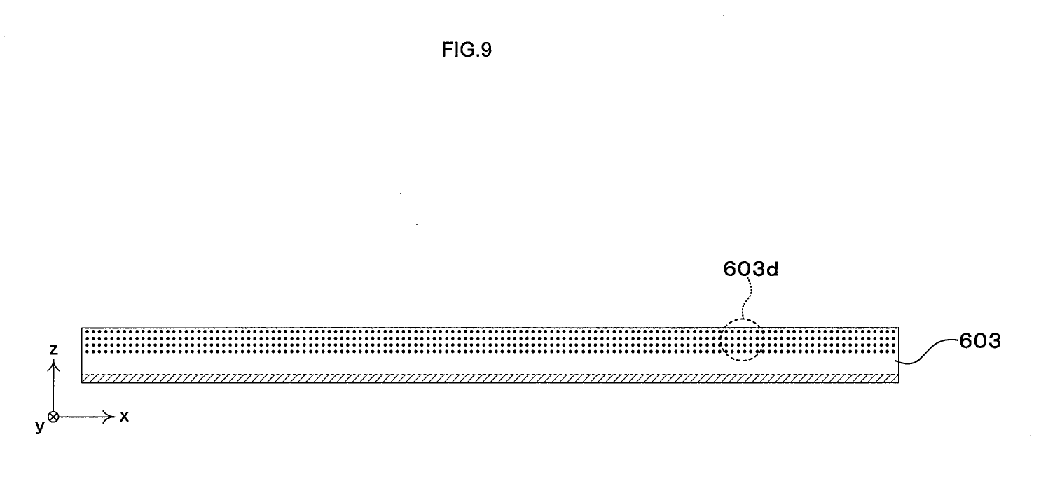

FIG. 9 is a view showing an example of another print pattern of silk printing applied to an elastic sheet in the second embodiment.

Plural dot-like patterns arranged as a convex portion 603d are silk printed on an elastic sheet 603.

The silk printing to form the convex portion 603d of the print pattern as shown in FIG. 9 is applied to the surface of the elastic sheet 603, so that a gap having the thickness of the convex portion 603d can be ensured between a cleaning blade 601 and the elastic sheet 603, and the surface contact (intimate contact) between the cleaning blade 601 and the elastic sheet 603 can be prevented. The convex portion 603d is formed between the cleaning blade 601 and the elastic sheet 603, so that the rotation operation of the cleaning blade 601 can be always kept in an excellent state, and the stabilization of the cleaning performance as the cleaning device can be obtained.

Incidentally, in the foregoing example, although the structure in which the convex portion is provided on the elastic sheet 603 is exemplified, the same effect can be obtained also by forming, for example, a concave portion on the elastic sheet 603. Besides, the method of forming the concave portion and the convex portion on the elastic sheet 603 is not limited to the silk printing, but, for example, press working, sand blast working, or corrosion working using a chemical solution may be used.

Besides, although the convex portion in the cleaning device has the structure in which the plural specified print patterns are arranged, only a single print pattern may be formed on the elastic sheet 603 as long as the intimate contact between the elastic sheet 603 and the cleaning blade 601 can be prevented consequently.

Incidentally, in the foregoing structural example, although the case where the cleaning object surface of the cleaning unit is the photoconductive surface of the photoconductive drum is exemplified, no limitation is made to this. The cleaning object of the cleaning unit may be various places having a possibility that unnecessary toner is attached, such as a belt surface of an intermediate transfer belt, a drum surface of an intermediate transfer drum, or a roller surface of a secondary transfer roller.

Besides, a process unit can be provided which integrally includes the cleaning device and at least one of other units such as a photoreceptor, a charging unit and a developing unit. It is needless to say that the process unit can be made to be attached to and detached from the image forming apparatus main body.

Besides, it is needless to say that the cleaning device can be applied to not only the image forming apparatus of the electrophotographic system in which an image is formed by using toner but also an image forming apparatus in which an image is formed by using ink.

Besides, in the foregoing example, although the structure in which the convex portion or the concave portion is provided on the elastic sheet is exemplified, a convex portion or a concave portion may be formed on the cleaning blade so that a gap to prevent intimate contact of the elastic sheet with the cleaning blade can be ensured consequently.

### Third Embodiment

A third embodiment will be described. Hereinafter, a portion having the same function as a portion in the foregoing structural example is denoted by the same reference numeral and its description is omitted.

Hitherto, in a secondary transfer unit for performing transfer of a toner image to a recording medium, such as a sheet, from an intermediate transfer belt, there is known a structure including a mechanism to supply a lubricant agent to a secondary transfer roller.

The secondary transfer unit as stated above includes a brush roller a brush tip of which contacts with a roller surface of a secondary transfer roller provided in the secondary transfer unit and supplies a lubricant agent, a solid lubricant agent, a spring to press the lubricant agent to the brush roller, a brush to fix a rotation shaft of the brush roller, a case to hold the brush roller, and a drive gear to transmit a rotation force from a drive source to the brush roller.

However, when there occurs a warp of the solid lubricant agent itself or a warp of a component to hold the lubricant agent, there occurs a part where the brush tip of the brush roller does not sufficiently contact with the lubricant agent, and there occurs an area where the lubricant agent is not sufficiently supplied to the secondary transfer roller.

In general, the warp is often generated to deform in a direction in which a surface of the lubricant agent opposite to the brush roller becomes a convex surface. As a result, a deviation in way of contact between the brush roller and the lubricant agent occurs, and there occurs a state where the supply of the lubricant agent to the vicinities of both ends in the rotation axis direction of the secondary rotation roller becomes insufficient.

The insufficiency in the amount of lubricant agent supply increases the friction coefficient of the surface of the secondary transfer roller, and there is a fear that curling of the cleaning blade to clean the surface of the secondary transfer roller is caused.

Then, in view of the above, a lubricant agent supply device having a structure as described below is disclosed.

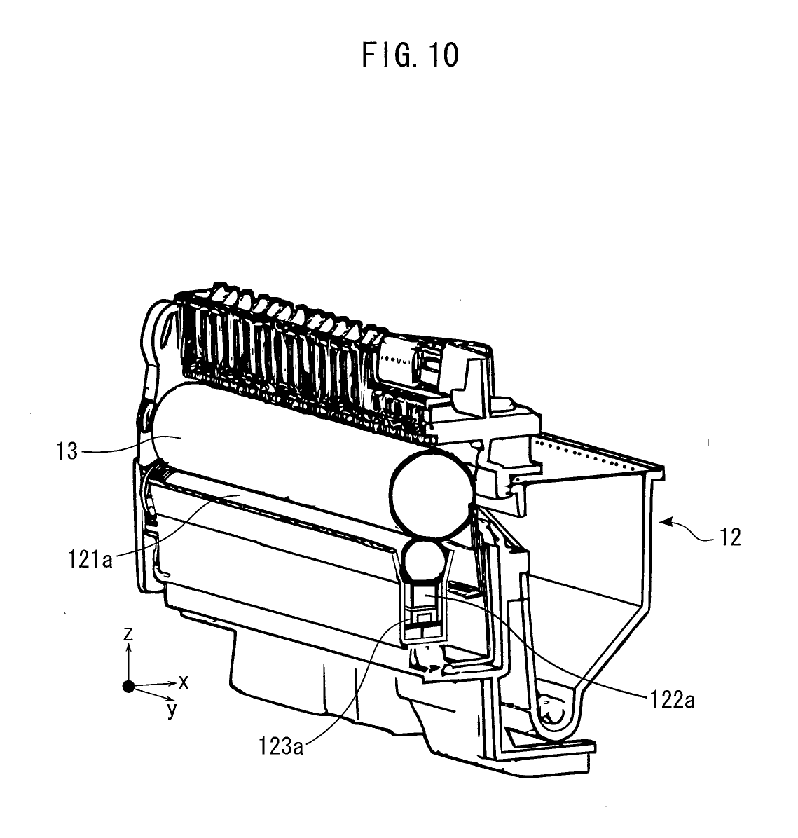

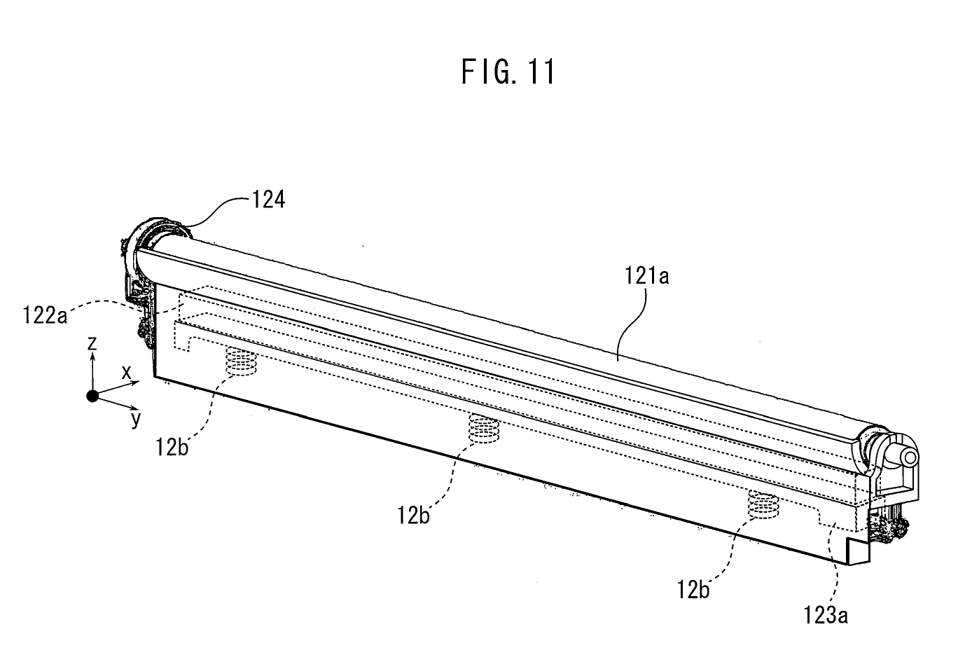

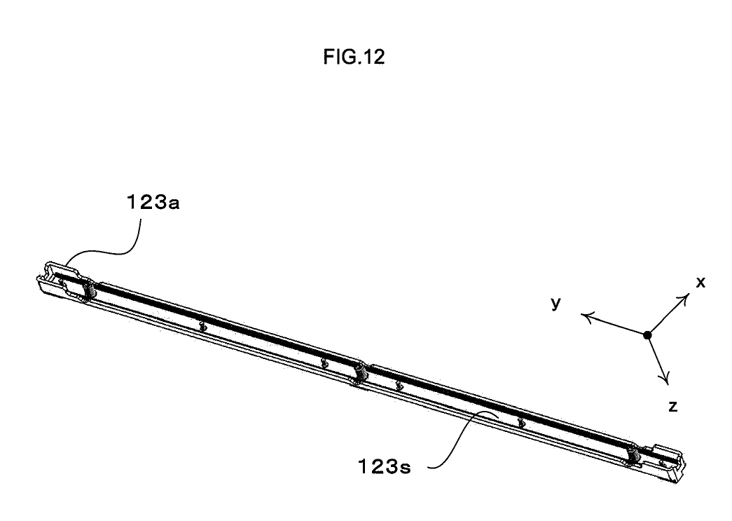

FIG. 10 is a perspective view of a secondary transfer unit 12 including the lubricant agent supply device. FIG. 11 is a perspective view of the lubricant agent supply device. FIG. 12 is a partial perspective view of a component of the lubricant agent supply device.

The lubricant agent supply device includes, for example, a brush roller 121a, a lubricant agent 122a, a base section 123a, a reinforcing member 123s, a drive gear 124 and a spring 12b.

The brush roller 121a rotates around an axis (axis parallel to a y-axis direction) parallel to a rotation axis of a second transfer roller 12t (rotator) as a lubricant agent supply object. The brush roller 121a contacts with the secondary transfer roller 12t (rotator as the lubricant agent supply object) of the secondary transfer unit 12 and supplies the lubricant agent.

The base section 123a holds the solid lubricant agent 122a, and elastically presses the lubricant agent 122a to the brush roller 121a by the spring 12b. The base section 123a can be formed of, for example, mold forming.

The reinforcing member 123s is fixed to a mount surface of the base section 123a on which the lubricant agent 122a is mounted, and reinforces the base section 123a so that the mount surface does not warp in a direction in which the mount surface becomes a convex surface (direction of protruding upward from the x-y plane in FIG. 10) (FIG. 12). As the reinforcing member 123s, for example, a metal plate can be adopted.

The drive gear 124 transmits a rotation force from a not-shown drive source to the brush roller 121a.

In general, in the base section 123a disposed in a narrow arrangement space and having a relatively thin and long shape, deformation such as a warp is relatively apt to occur due to mold forming and the like. The warp of the base section 123a due to such a deformation causes unevenness in the degree of contact of the brush roller 121a and the lubricant agent 122a in the rotation axis direction. Then, the reinforcing member 123s is fixed to the surface of the base section 123a on the side where the lubricant agent 122a is held, reinforces to prevent the warp of the base section 123a, and the brush roller 121a and the lubricant agent 122a are made to uniformly come in contact with each other in the rotation axis direction.

### Fourth Embodiment

A fourth embodiment will be described.

The fourth embodiment is a modified example of the third embodiment. Hereinafter, a portion having the same function as a portion in the foregoing structural example is denoted by the same reference numeral and its description is omitted.

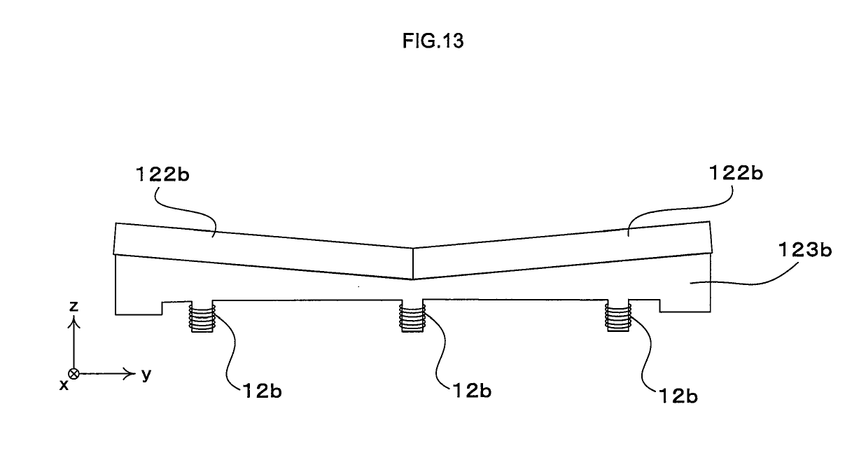

FIG. 13 is a view of a structure of a lubricant agent supply device of the fourth embodiment.

In a base section 123b, a surface on which a lubricant agent 122b is mounted is an inclined surface in which an end portion in a rotation axis direction of a secondary transfer roller 12t is higher (approaches a brush roller) than a center portion.

The two-piece lubricant agent 122b is bonded to the inclined surface to hold the lubricant agent 122b in the base section 123b. That is, in the state where the lubricant agent 122b is fixed to the base section 123b, the surface of the lubricant agent 122b opposite to the brush roller is a concave surface.

### Fifth Embodiment

A fifth embodiment will be described.

The fifth embodiment is a modified example of the fourth embodiment. Hereinafter, a portion having the same function as a portion in the foregoing structural example is denoted by the same reference numeral and its description is omitted.

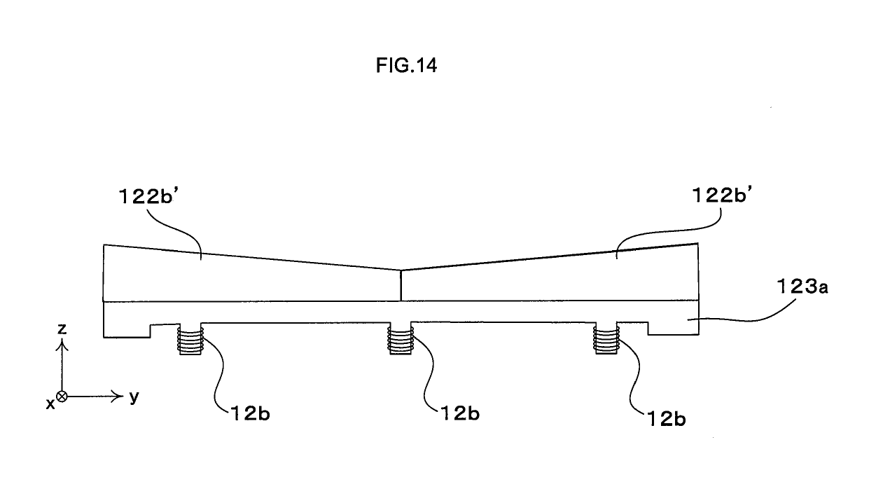

FIG. 14 is a view of a structure of a lubricant agent supply device in the fifth embodiment.

A lubricant agent 122b′ has such a shape that an end portion thereof in a rotation axis direction of a secondary transfer roller 12t (direction parallel to a y-axis direction) is closer to a brush roller than a center portion.

Specifically, the surface of the lubricant agent 122b′ opposite to the brush roller is such an inclined surface that the end portion in the rotation axis direction is higher than the center portion.

Besides, the lubricant agent 122b′ is halved at the center position in the rotation axis direction.

### Sixth Embodiment

A sixth embodiment will be described.

The sixth embodiment is a modified example of the third embodiment. Hereinafter, a portion having the same function as a portion in the foregoing structural example is denoted by the same reference numeral and its description is omitted.

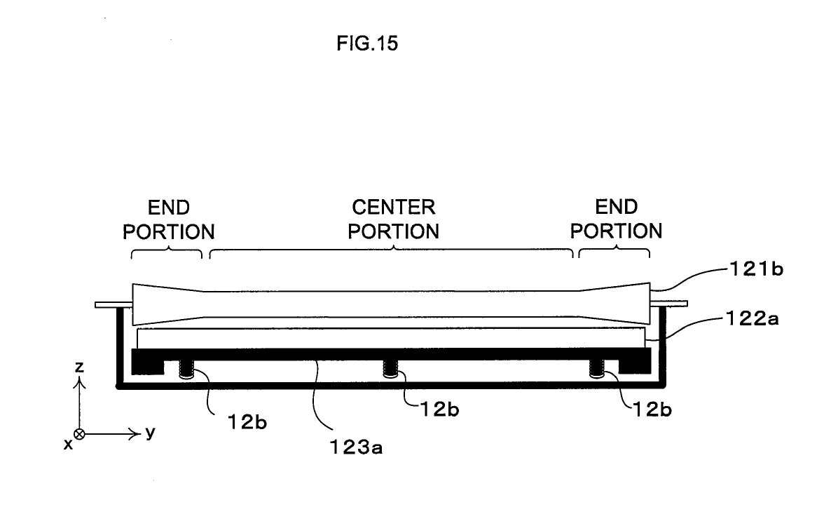

FIG. 15 is a structural view of a lubricant agent supply device of the sixth embodiment.

A brush roller 121b has such a shape that an end portion of a brush front edge of the brush roller 121b in a rotation axis direction (direction parallel to a y-axis direction) is closer to a lubricant agent 122a than a center portion.

Specifically, the brush front edge of the brush roller 121b has such a shape as to gradually approach the lubricant agent 122a from both ends of the center portion to the end portion in the rotation axis direction (FIG. 15).

### Seventh Embodiment

A seventh embodiment will be described.

The seventh embodiment is a modified example of the third embodiment. Hereinafter, a portion having the same function as a portion in the foregoing structural example is denoted by the same reference numeral and its description is omitted.

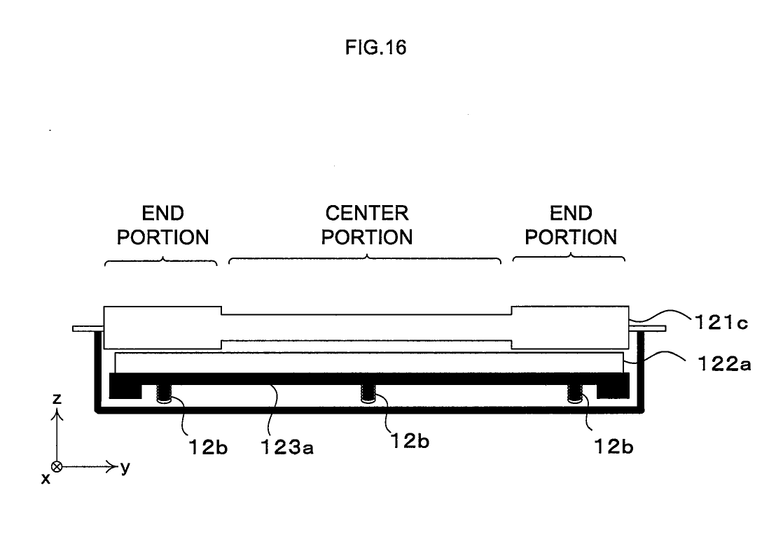

FIG. 16 is a view of a structure of a lubricant agent supply device of the seventh embodiment.

A brush roller 121c has such a shape that an end portion of a brush front edge of the brush roller 121c in a rotation axis direction (direction parallel to a y-axis direction) is closer to a lubricant agent 122a than a center portion.

Specifically, the brush roller 121c has such a stepped shape that the brush front edge of the brush roller 121c approaches (becomes thick) the lubricant agent 122a stepwise from the center portion in the rotation axis direction to the end portion (FIG. 16).

According to the respective embodiments, even in the state where the lubricant agent warps, a sufficient amount of lubricant agent can be supplied to the vicinities of both ends, in the rotation axis direction, of the rotator as the lubricant agent supply object. For example, the lubricant agent can be sufficiently supplied to the roller surface of the secondary transfer roller cleaned by the cleaning blade, and as a result, the occurrence of curling or the like of the cleaning blade can be suppressed.

According to the respective embodiments, for example, techniques (1) to (7) described below can be provided.

(1) A lubricant agent supply device includes

a brush roller to rotate around an axis parallel to a rotation axis of a rotator as a lubricant agent supply object,

a base section to hold a solid lubricant agent and to press the lubricant agent to the brush roller, and

a reinforcing member which is fixed to a mount surface of the base section on which the lubricant agent is mounted and reinforces the base section so that the mount surface does not warp in a direction in which the mount surface becomes a convex surface.

(2) In the device of (1),

the lubricant agent has such a shape that an end portion in a rotation axis direction is closer to the brush roller than a center portion.

(3) In the device of (1),

a surface of the lubricant agent opposite to the brush roller is such an inclined surface that an end portion in a rotation axis direction is higher than a center portion.

(4) In the device of (2) or (3),

the lubricant agent is halved at a center position in the rotation axis direction.

(5) In the device of (1),

the brush roller has such a shape that an end portion of a brush front edge of the brush roller in a rotation axis direction is closer to the lubricant agent than a center portion.

(6) In the device of (1),

the brush roller has such a shape that a brush front edge of the brush roller gradually approaches the lubricant agent from a center portion in a rotation axis direction to an end portion.

(7) In the device of (1),

the rotator as the lubricant agent supply object is a secondary transfer roller.

The present invention can be carried out in various forms without departing from the sprit or main features thereof. Therefore, the foregoing embodiments are merely exemplary in all points and should not be restrictedly interpreted. The scope of the invention is defined by the claims and is not restricted by the text of the specification. Further, all modifications, various improvements, substitutions and alterations belonging to the equivalent range of the claims are within the scope of the invention.

As described above in detail, according to the technique disclosed in the specification, the performance of the cleaning blade in the cleaning unit can be stably maintained.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. A cleaning device comprising:
a cleaning blade;
a support section to support the cleaning blade while pressing an end portion of the cleaning blade to a cleaning object surface;
a container which has an opening portion at a side opposite to the cleaning object surface and contains a removal object scraped from the cleaning object surface by the cleaning blade; and
an elastic sheet one end of which is fixed to a peripheral portion of the opening portion of the container, the other end of which is in contact with a non-opposite surface as a surface of the cleaning blade at a side not opposite to the cleaning object surface, and which guides the removal object scraped from the cleaning object surface by the cleaning blade into the container, and includes, on at least a part of a surface opposite to the cleaning blade, a slope-shaped portion having a side surface inclined to both the non-opposite surface and the surface of the elastic sheet opposite to the cleaning blade in a state of contact with the non-opposite surface.

2. The device of claim 1, wherein
the elastic sheet has at least one of a concave portion and a convex portion in a surface area which is at least the part of the surface opposite to the cleaning blade.

3. The device of claim 2, wherein
the convex portion is a print pattern by silk printing.

4. The device of claim 2, wherein
at least one of the concave portion and the convex portion includes a plurality of arranged patterns of a specified shape.

5. The device of claim 2, wherein
at least one of the concave portion and the convex portion is a linear pattern extending in a direction perpendicular to a direction of relative movement of the cleaning object surface and the cleaning blade.

6. The device of claim 2, wherein
at least one of the concave portion and the convex portion includes a plurality of arranged dot-like patterns.

7. The device of claim 1, wherein
the cleaning object surface is one of a photoconductive surface of a photoconductive drum to carry a toner image, a transfer surface of an intermediate transfer body to carry the toner image transferred from the photoconductive drum, and a roller surface of a secondary transfer roller to transfer the toner image on the intermediate transfer body onto a recording medium.

8. The device of claim 1, wherein
the support section supports the cleaning blade to rotate the end portion of the cleaning blade around a support shaft.

9. The device of claim 1, wherein
the cleaning blade is made of polyurethane elastomer, and the elastic sheet is made of a polyester film.

10. A cleaning performance maintaining method for a cleaning device including a cleaning blade, a support section to support the cleaning blade while pressing an end portion of the cleaning blade to a cleaning object surface, a container which has an opening portion at a side opposite to the cleaning object surface and contains a removal object scraped from the cleaning object surface by the cleaning blade, and an elastic sheet one end of which is fixed to a peripheral portion of the opening portion of the container, the other end of which is in contact with a non-opposite surface as a surface of the cleaning blade at a side not opposite to the cleaning object surface, and which guides the removal object scraped from the cleaning object surface by the cleaning blade into the container, comprising:
causing a slope-shaped portion, which is provided on at least a part of a surface of the elastic sheet opposite to the cleaning blade and has a side surface inclined to both the non-opposite surface and the surface of the elastic sheet opposite to the cleaning blade in a state of contact with the non-opposite surface, to lie between the cleaning blade and the elastic sheet and preventing surface contact between the cleaning blade and the elastic sheet.

11. The method of claim 10, wherein
the elastic sheet has at least one of a concave portion and a convex portion in a surface area which is at least the part of the surface opposite to the cleaning blade.

12. The method of claim 11, wherein
the convex portion is a print pattern by silk printing.

13. The method of claim 11, wherein
at least one of the concave portion and the convex portion includes a plurality of arranged patterns of a specified shape.

14. The method of claim 11, wherein
at least one of the concave portion and the convex portion is a linear pattern extending in a direction perpendicular to a direction of relative movement of the cleaning object surface and the cleaning blade.

15. The method of claim 11, wherein
at least one of the concave portion and the convex portion includes a plurality of arranged dot-like patterns.

16. The method of claim 10, wherein
the cleaning object surface is one of a photoconductive surface of a photoconductive drum to carry a toner image, a transfer surface of an intermediate transfer body to carry the toner image transferred from the photoconductive drum, and a roller surface of a secondary transfer roller to transfer the toner image on the intermediate transfer body onto a recording medium.

17. The method of claim 10, wherein
the support section supports the cleaning blade to rotate the end portion of the cleaning blade around a support shaft.

18. The method of claim 10, wherein
the cleaning blade is made of polyurethane elastomer, and the elastic sheet is made of a polyester film.
